(19) United States
(12) Patent Application Publication
(10) Pub. No.: US 2009/0076863 A1
(43) Pub. Date: Mar. 19, 2009

(54) Designated user enabled retailing system

(75) Inventors: Roger E. Kraft, Fort Scott, KS (US); William R. Russell, Pittsburg, KS (US); Rachel E. Wells, Fort Scott, KS (US)

Correspondence Address: Ward/Kraft, Inc.;Attn: Stephanie Hay, 2401 Cooper Street, P. O. Box 938, Fort Scott, KS, 66701, US

(73) Assignee: Ward/Kraft, Inc.

(21) Appl. No.: 11/901,217

(22) Filed: Sep. 14, 2007

(51) Int. Cl. G06Q 30/00; G06F 17/40; G06F 3/01

(52) U.S. Cl. 705/5; 705/10; 705/27

(57) ABSTRACT

The present invention relates to a user enabled product and service fulfillment system in which a cell phone is used to enter prompts for products and services. The system of the present invention enables users to regularly receive products and or services that are routinely ordered without the necessity of having to re-enter such products or services each time a user connects with the system. The user may also supplement each order with available additional products or service offerings which are not routinely ordered by the user.

### CROSS-REFERENCES TO RELATED APPLICATIONS

None.

### FIELD OF THE INVENTION

The present invention relates to a user enabled, or frequent user retailing system in which a designated, registered or repeat customer can arrange to have regular products and services repeatedly delivered to him or her, or alternatively or in combination, arrange for disparate products and services from a readily available menu of offerings to be delivered along with the regular order or as a supplement to the standard order configuration. The present invention enables a repeat or registered customer to easily arrange for repeat services or products through the use of cell phones or other traceable mechanisms such as bar coded labels, magnetic stripe encoded membership cards or the like.

### BACKGROUND OF THE INVENTION

There are a myriad of retail and private club offerings available today for consumers for all sorts of products and services. Yet with so many options, the opportunities to improve on retail services and meet the demands of today's “on the go” consumer are almost limitless. In addition, many of these offerings while suggesting they can be tailored to meet the individual needs of a subscriber simply are unavailable in certain areas of the country or to particular demographics of a population and have commonly only been offered in the largest metropolitan areas.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention is a convenience based retailing and loyalty system that allows registered users to arrange for the delivery of regularly occurring products or services without the necessity of having to repeatedly enter order sequences for such products or services. In addition, the system of the present invention permits the registered users to supplement a regular order with additional products and services from a broader range of offerings. This convenience based system employs readily accessible technology platforms, such as cellular phone units, to capture the identity of the user, such as through a phone or account number as well as to potentially track the location of the user, via global positioning satellites (“GPS”), or triangulation of the cell phone signal to determine the position of the user so that the order can be prepared and delivered in a timely basis, such as when the user arrives at a fulfillment location or the like. Alternatively, the user can prearrange to have the products and services delivered to the home residence or temporary living accommodations.

In one exemplary embodiment of the present invention, a user enabled retailing system is described and includes in part a user registration data base. The user registration data base has a user identification number and at least a first user remuneration account number and a selection of predetermined products or services associated with the user identification number. In this manner, when a user signs in, the user can easily have products and services that he or she normally uses prepared for fulfillment without the need for re-entry of the same products and services.

The presently described embodiment also includes a first product menu with the first product menu having a group of consumer product offerings that may be selected from a generic group or from other specific demographically arranged product offerings.

A first service menu is provided with the first service menu having a group of consumer service offerings that again may be chosen from a generic listing of service offerings or a specific group of offerings that may appeal to a particular demographic group of individuals.

Continuing with a discussion of the presently described embodiment, a user interface mechanism is included with the system, the user interface mechanism allows the user, after he or she has been identified or submitted to other verification clearance, to select at least one item from each of the product menu and the service menu. The presently described embodiment further includes a fulfillment means so as to be able to deliver the products and/or services to the registered user. The fulfillment means provides the user with the predetermined products or services and at least one item from each of the product menu and the service menu.

In a further exemplary embodiment of the presently described invention, user enabled product fulfillment and retailing system is described and includes a user identification and tracking device, such as a cell phone, magnetic stripe encoded membership card or the like.

The system of this embodiment includes a first data set that contains regularly ordered items for each of a plurality of registered users, the data set contains selected groups of information that are specific to each of the plurality of registered users. A fulfillment center that has at least an inventory of available products provides as a reservations agent to establish service commitments for available service offerings. The system embodiment presently described includes a distribution location for distributing the regularly ordered items to each of the plurality of registered users.

In order to ascertain the success of the particular system and the offerings provided to the users, a second data set is provided for collecting information on each of the plurality of registered user purchasing habits.

In a still further exemplary embodiment of the presently described invention, a user enabled system for providing products and services to registered users is described and includes a first database that contains a group of products with at least one of the group of products including consumer food products.

A second database is provided in connection with the presently described embodiment and the second database contains a group of services with at least one of the group of services including personalized printing services. Each of the first and second databases are used to create a first user set of regular products and services for each of a series of registered users.

A third database is available and contains supplemental products and services that are distinct from the products and services which are contained in the first and second databases with at least one of the supplemental products and services including air travel services.

The presently described embodiment of the system includes an enabling device specific for each of the series of registered users. Such an enabling device may include a cell phone which can be used to identify each of the users as well as to aid in locating the position of the user. A fulfillment center is provided such that each of the products and services selected by each of the series of registered users can be made available and delivered to the user.

Product offerings that may be provided in connection with the presently described invention are selected from a group including consumer product offerings, sundries and related type consumer products.

Service offerings that may be provided in connection with the presently described invention are normally consumer oriented in their focus and provide services that are regularly requested by private individuals and otherwise as defined herein.

The presently described invention may also make use of concierge type services in which an individual can arrange various appointments, service upgrades, adjust scheduling conflicts and cancellations and generally provide of the individual needs of the registered user group.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a schematic of an exemplary system of the presently described invention;

FIG. 2 provides an exemplary flow diagram which shows a transaction flow for the system; and

FIG. 2 shows a flow diagram illustrating a supplemental service selection enabled by the system.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

As used herein consumer product offerings include food products intended for human and animal consumption.

As used herein sundries includes products that are regularly used in everyday activities such as detergent, personal care products (e.g. shampoo, deodorant, toothpaste, sanitary products and the like) camping and vacation supplies (e.g. matches, charcoal, firewood, repellants and the like).

As used herein consumer service offerings include air taxi services, personalized printed products, dry cleaning services, delivery services (expedited courier services, parcel post, personal delivery and the like), vacation services, concierge services (e.g. shopping and dining assistance, reservations, travel planning, directions and the like).

As used herein predetermined product or service offerings includes at least one of each of consumer product offerings and consumer service offerings.

As used herein remuneration means includes at least one of credit card accounts, banking accounts (e.g. savings, checking), brokerage accounts, pre-paid accounts, gift cards and certificates, fleet accounts and the like.

As used herein fulfillment means generally refers to delivering or providing products or services to the user requesting the products and/or services. The fulfillment means includes personal delivery services, express courier, parcel post, expedited courier services such as overnight carriers and the like.

The present invention is a system by which a registered user can obtain a variety of products and services as well as arrange for regularly ordered products and services to be provided directly to the user on a regular basis without the necessity of having to reorder or re-enter the request for such product and services. The system utilizes a readily available technology platform, such as a cell phone in order to quickly identify the user of the service and to potentially allow for the user to be tracked such as through triangulation of the device by locating the signal emitter.

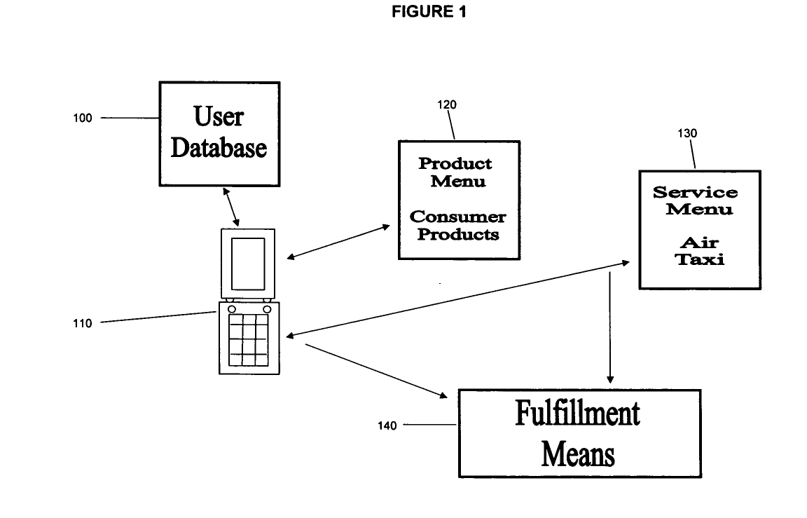

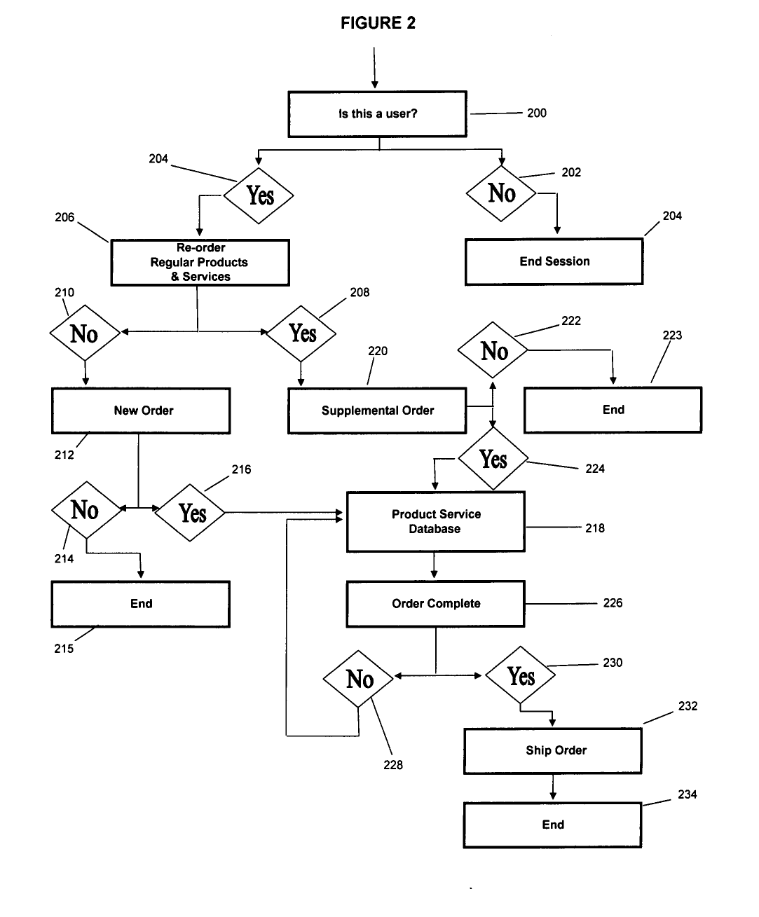

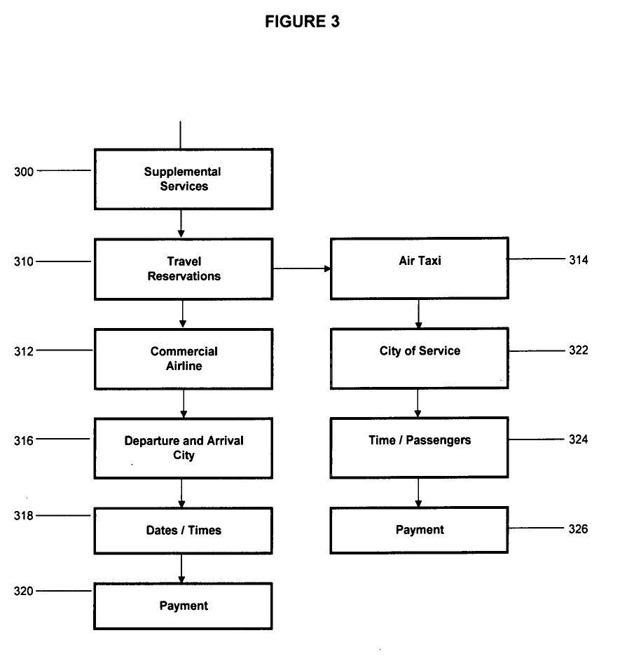

Turning now to FIG. 1 which generally depicts a schematic of a system in which a user database 100 is provided and contains information on a number of pre-registered users or account holders. Operation of the system will be explained in greater detail in connection with the description associated with FIG. 2.

The information related to each user may include general information such as name, address, age as well as ordering preferences, account numbers, payment preferences and the like. The information contained in database 100 may also include delivery preferences for the particular goods or services that are to be ordered or delivered to the user.

The user connects to the system through use of a device such as a cell phone 1 10. The user first logs into the system and would be prompted to select “yes” or “no” in order to receive the regularly recurring products and services that the user receives at normal intervals, such as weekly or monthly. If the user does not log into the system, then the system will not arrange for the delivery of products or services.

Continuing with a discussion of FIG. 1, the user then may select items from the supplement product and service menus or databases, show as reference numerals 120 and 130, respectively. In each of these menus, 120 and 130, a plurality of items is provided ranging from consumer food products to personal care products in the product menu 120 and from personalized printed products to air taxi services in the service menu 130.

Once the data is entered by the user by the user interface 110, such as by touching the number keys on the cell phone in response to the selections offered via voice commands from the system, then the order is collected, packaged for delivery at the fulfillment center 140 and then sent out for delivery. Delivery of the products can be accomplished by any conventional means, courier, postal service, personal delivery and the like. The fulfillment center 140 may also serve as the delivery location or can arrange for third party fulfillment through another company or the like.

Attention is now directed to FIG. 2 of the presently described embodiment which shows a flow diagram of an exemplary transaction contemplated by the system. Upon receiving a call from a potential user of the system, the system queries whether the caller is an actual customer or registered user at 200. If the system determines it is not a user at 202, such as by checking the phone number of the device making the inquiry, then the session will end at 204.

If the system reacts and validates the user at 204 it will then prompt the user as to whether he or she is interested in receiving the regularly ordered products and services at 206. The user will respond, again by using the cell phone or other user enabled device either “yes” 208 or “no” 210. The response of “yes” or “no” can be input via the cell phone such as by touching the number “1” and “2” key respectively.

If the user responds “no” at 210, then the system queries whether a new order is to be placed at 212. Again the user needs to respond as “yes” or “no” at 214 and 216, respectively. If “no” is the response entered at 214, the session will end 215.

If the user has responded “yes” at 216 then the user is provided with various product and/or service selections by the product and service database 218.

Reverting to an earlier sequence in FIG. 2, if a “yes” response is provided at 208, the user will be prompted again as to whether a supplemental order 220 is to be entered. The user will respond with a “no” or “yes”, 222 and 224, respectively, again by entering the numerals “1” or “2” on the number pad of the cell phone. If a “no” is selected then the system session will again end at 223.

When the user selects “yes” at 224, then the user is prompted by the product and/or service database 218. After each selection from the product/service database 218, the user will be asked whether the order is complete at 226. Each time if the user selects “no” at 228 the user is then prompted again to enter another selection from the product/service database 218. If the user enters “yes” at 230, then the order is prepared and shipped from the fulfillment center at 232 and the session ends at 234.

There are of course many permutations as to how a transaction my flow when a user logs on to the system and those variations would of course be dependent on the type of product or service that has been selected. A further exemplary embodiment is shown for example by the flow chart provided in FIG. 3.

If a user selects supplemental services 300 for example, a transaction illustrated in FIG. 3, the user may further select the travel reservations option 310, again by pressing the representative number on the keyboard corresponding the desired option. From the travel reservation option 310, the user can select for example commercial airline reservations 312 or air taxi service 314.

If the commercial airline reservation option is selected, then the user is walked through several additional prompts and requested to input information again through the key pad on the cell phone for each prompt 316—departure and arrival city, 318—dates and times and 320 payment. During certain times, the system may recognize numeric entries and other letter entries, such as when entering departure and arrival destinations, passengers names and the like.

Should the air taxi service be selected at 314, the user may enter the city of service 322, time and passenger information 324 and payment details 326. Again the system would allow toggling between alpha and numeric keys to allow entry of the pertinent information. Alternatively, the user may opt for voice between the system and user, at which time the system would connect the user with a customer service representative.

The user may have pre-programmed payment information, multiple credit cards or accounts, and can easily select from the options provided to provide for payment. This would be applicable not only to the supplemental service example provided in FIG. 3 but also to arrange for payment for the normal flow of products and services.

It will thus be seen according to the present invention a highly advantageous personalized consumer product and service offering has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A user enabled retailing system, comprising;
a user registration data base, said data base including a user identification number and at least a first user remuneration account number and a selection of predetermined products or services associated with said user identification number;
a first product menu, said first product menu having a group of consumer product offerings;
a first service menu, said first service menu having a group of consumer service offerings;
a user interface mechanism, said user interface mechanism allowing said user after identification verification to select at least one item from each of said product menu and said service menu;
a fulfillment means; and
wherein said fulfillment means provides said user with said predetermined products or services and at least one item from each of said product menu and said service menu.

2. A user enabled retailing system as recited in claim 1, wherein said first product menu is selected from a group including food products, convenience products and sundries.

3. A user enabled retailing system as recited in claim 1, wherein said first service menu includes air taxi services.

4. A user enabled retailing system as recited in claim 1, wherein said first service menu includes personalized printed products.

5. A user enabled retailing system as recited in claim 1, wherein said first service menu includes dry cleaning services.

6. A user enabled retailing system as recited in claim 1, wherein said first service menu includes vacation planning services.

7. A user enabled retailing system as recited in claim 1, wherein said remuneration account number includes credit card and banking account information.

8. A user enabled retailing system as recited in claim 1, wherein said user interface mechanism is selected from a group including a cell phone, bar code, government issued identification and combinations thereof.

9. A user enabled retailing system as recited in claim 1, wherein said fulfillment means is selected from a group that includes express courier service, parcel post, overnight service, regular mail service and personal delivery service.

10. A user enabled retailing system as recited in claim 1, wherein said predetermined products or services is selected from a group including food products, convenience products, sundries, personalized printing products and dry cleaning services.

11. A user enabled retailing system as recited in claim 1, wherein said service menu includes a concierge service option.

12. A user enabled retailing system as recited in claim 11, wherein said concierge service option includes shopping and dining assistance, travel planning, reservations, directions and combinations thereof.

13. A user enabled product fulfillment and retailing system, comprising;
a user identification and tracking device,
a first data set containing regularly ordered items for each of a plurality of registered users, said data set containing selected groups of information specific to each of said plurality of registered users;
a fulfillment center having at least an inventory of available products and a reservations agent to establish service commitments for available service offerings;
a distribution location for distributing said regularly ordered items to each of said plurality of registered users; and
a second data set for collecting information on each of said plurality of registered user purchasing habits.

14. A user enabled product fulfillment and retailing system as recited in claim 13, wherein said user identification and tracking device is a cell phone.

15. A user enabled product fulfillment and retailing system as recited in claim 13, wherein said second data set includes a feedback survey for collecting information on each of said plurality of registered users.

16. A user enabled product fulfillment and retailing system as recited in claim 13, wherein said system further includes a third data set providing supplemental products and services.

17. A user enabled product fulfillment and retailing system as recited in claim 16, wherein said supplemental service includes a concierge service.

18. A user enabled product fulfillment and retailing system as recited in claim 16, wherein said supplemental services include personalized printing services.

19. A user enabled product fulfillment and retailing system as recited in claim 16, wherein said supplement services include air taxi and travel assistance services.

20. A user enabled system for providing products and services to registered users, comprising;
a first database containing a group of products with at least one of said group of products including consumer food products;
a second database containing a group of services with at least one of said group of services including personalized printing services;
each of said first and second databases are used to create a first user set of regular products and services for each of a series of registered users;
a third database containing supplemental products and services distinct from said products and services contained in said first and second databases and at least one of said supplemental products and services including air travel services;
a system enabling device specific for each of said series of registered users; and
a fulfillment center for providing each of said products and services selected by each of said series of registered users.
